(19) United States
(12) Patent Application Publication
(10) Pub. No.: US 2009/0276732 A1
(43) Pub. Date: Nov. 5, 2009

(54) SYSTEM AND METHOD FOR STORAGE, DISPLAY AND REVIEW OF ELECTRONIC MAIL AND ATTACHMENTS

(76) Inventor: LUCIAN EMERY DERVAN, MELBOURNE, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/428,462

(22) Filed: Apr. 22, 2009

Related U.S. Application Data
(60) Provisional application No. 61/047,097, filed on Apr. 22, 2008.

(51) Int. Cl. G06F 15/16; G06F 3/048

(52) U.S. Cl. 715/853; 709/206

(57) ABSTRACT

A method for managing email messages. The method comprises: (a) identifying a root email message sent by a first party to a second party; (b) assigning a tracking identifier to the root email message, (c) linking the tracking identifier and the root email message, (d) identifying first branch email messages branching from the root email message, wherein each of the first branch email messages comprises an email message having one or more elements in common with the root email message, (e) storing the root email message and elements of any first branch email message not previously stored, (f) assigning to each first branch email message a same first branch identifier, (g) assigning to each first branch email message a unique serial identifier identifying the location of each email message in the first branch, (h) linking each first branch email message to the corresponding tracking identifier of the root email message, the first branch identifier and the unique serial identifier, (i) repeating steps (d)-(h) for email messages branching from the root email message along branches other than the first branch and (j) displaying the root email message and elements of any branch email message that were not displayed as elements of a previously-displayed email message.

### CLAIM OF PRIORITY

This application claims priority under 35 U.S.C. section 119(e) to U.S. Provisional Patent Application Ser. No. 61/047,097, filed on Apr. 22, 2008, the entire contents of which are hereby incorporated by reference.

### FIELD OF THE INVENTION

This invention relates to a system and method using hardware and software for the collection, storage, monitoring, and review of emails and email attachments.

### BACKGROUND OF THE INVENTION

Corporations today must spend millions of dollars annually to backup and store emails. This is not simply a decision by corporations to maintain copies of corporate materials for convenience and future reference, it is often a requirement under state and federal statutes and regulations and the availability of these copies is essential during litigation. As such, corporations are constantly in search of cheaper and more efficient media for storing these voluminous materials.

While securing adequate front-end storage of emails is a significant concern for corporations, real time monitoring and back-end retrieval and review of emails as part of security protocols, compliance reviews, internal audits, litigation preparation and response, and government subpoena compliance is also a major consideration. Failure to have viable constant access to emails can result not only in a failure to properly respond to these scenarios but can lead to charges of civil or criminal contempt or obstruction of justice.

Existing systems for email storage require extensive memory to retain multiple copies of each email. Furthermore, no effective or efficient method exists for real time monitoring of email communications in an entire network. Finally, where after-the-fact review of emails must occur, available options are severely limited and include printing all emails in hard copy for manual review, reviewing all emails in their native format, and application of de-duplication software after-the-fact, which is severely hampered due to the limitations of such existing software.

The invention described herein, referred to as a DSS Platform, addresses all collection, storage, monitoring, retrieval, and review needs for email correspondence.

### BRIEF DESCRIPTION OF THE DRAWINGS

FIGS. 1A and 1B illustrate, respectively, stored information, with identifying notations, of a conventional email string and the same content as generated by the DSS platform of the present invention.

FIG. 2 illustrates stored information, with identifying notations, of a complex email chain or thread.

FIG. 3 illustrates stored information of the content of FIG. 2 as generated by the DSS platform of the present invention.

FIGS. 4A and 4B illustrate stored information, with identifying notations, of two different email strings.

FIGS. 5A and 5B illustrates stored information for the respective FIGS. 4A and 4B email strings as generated by the DSS platform of the present invention.

FIG. 6 illustrates the DSS Platform's “Forest View” display from a global position, where each box represents an email message and the box closest to the center dot in each “branch” is a “root” email.

FIGS. 7A and 7B illustrate two examples of a display of a “chain” in the DSS Platform monitoring/review system

FIG. 8 illustrates a “Spoke and Wheel” display in the DSS Platform monitoring/review system.

FIG. 9 illustrates an “Offsite Exchange” display in the DSS Platform monitoring/review system showing an email string where the email is sent outside the network and later returns to the network.

FIG. 10 illustrates a display of the manner in which reviewed emails are marked as such in the DSS Platform monitoring/review system.

FIG. 11 illustrates a display of the monitoring/review panel of the DSS platform for a simple email string.

FIG. 12 illustrates a display of the monitoring/review panel of the DSS platform for a complex email string.

FIG. 13 illustrates steps of a software process implementing one embodiment of the present invention.

### DETAILED DESCRIPTION OF INVENTION

Before describing in detail the particular methods and apparatuses for collecting, storing, monitoring and reviewing emails and email attachments, in accordance with the various embodiments of the present invention, it should be observed that these embodiments reside primarily in a novel combination of hardware and software elements related to the claimed methods and apparatuses. Accordingly, the hardware and software elements have been represented by conventional elements in the drawings, showing only those specific details that are pertinent to the presented embodiments, so as not to obscure the disclosure with details that will be readily apparent to those skilled in the art having the benefit of the description herein.

The following embodiments are not intended to define limits as to the structures or methods of the invention but only to provide exemplary constructions. The embodiments are permissive rather than mandatory and illustrative rather than exhaustive.

The various embodiments of the invention comprise a platform that provides one or more of the following features:
(1) Reduces the storage space required to maintain accessible copies of all email communications.
(2) Allows for easier real-time monitoring, retrieval, and review of emails, without repetitious review of repeated content.
(3) Creates a “Forest View” of each email chain from the first email in the chain to the last to present a visual overview of the exchange, including information regarding the time sent/received, participants (both from within and outside the existing network), and key terms within any of the emails.
(4) Monitors and searches for specific users, terms, or patterns and flags these emails for reviewers conducting real-time monitoring or after-the-fact review.
(5) Permits the user to uncompress the emails into their original format when necessary for document production or other disclosures.

The described embodiments allow collecting, storing, monitoring, and reviewing of emails and their attachments. The system comprises a device, such as a computer or microprocessor that intercepts (receives) and analyzes email communications entering and leaving a computer network, e.g. a corporation's email servers. The system analyzes and sorts each email to locate related emails. Where the email is related to previous communications, it is de-duplicated and any new content is placed within an existing email chain according to a “root,” “tree,” and “branch” structure. All email communications are stored in this “compressed” format with a supplemental record of each email in its original uncompressed format.

Real-time monitoring or after-the-fact review of the emails may be made utilizing the system's email review mechanism, which presents a visual overview of each email chain, including information regarding the time, participants/recipients (both from within and outside the existing network), and key terms. Furthermore, the system can be set to monitor or search for specific users, terms, or patterns and flag these emails for reviewers conducting real time monitoring or after-the-fact review.

The DSS Platform can also be used on the back-end, such as when working with archived emails when the DSS Platform has not been employed at the time the emails were created. When so used, the DSS Platform uses unique identifiers such as the subject line, to/from, time, and key words to link email messages that otherwise might appear unrelated. It is observed, however, that when the subject line has been removed and the original text deleted, few unique identifiers are available to create the email string and link the emails. As such, it is more desirable to utilize the DSS Platform on the front-end whenever possible.

### The Basic DSS Root, Tree, and Branch Structure

In the DSS Platform, the original email is retained and referred to as the “root” email message. Then a “tree” is created from the “root,” with “branches” representing the different paths of the email exchanges. Unlike conventional email storage systems, the DSS Platform only adds to the “tree” the relevant send/receive information (including to/from/cc/bcc/time/subject) and new text from the body of each new email message, rather than again storing the entire email chain from beginning to end every time a new communication occurs, e.g., as a reply to or forwarding of the last email in the email string. Later review of all the email messages is accomplished by simply reviewing the material in the “tree”. The contents of the “tree” is thus referred to as a compressed view of all the email messages.

Under this system, for example, the body of the original “root” message is only stored (and displayed to a reviewer) once rather than each time someone responds to the root message. The advantages of this system include at least the following:
(1) Less data storage space required.
(2) Easier retrieval and review.
(3) Easy printing of the “root,” “tree,” and “branch” for review or hard-copy filing.
(4) Easy overview of email communications with review of the “root,” “tree,” and “branch” structure.

Creating the DSS compressed view for storing and monitoring/reviewing is accomplished by assigning each email created in the network, for example using the “new message” button of any email application, a unique tracking identifier (e.g., comprising alphanumeric characters). As such, when the “new message” button in any email program, such as Microsoft® Outlook®, is “pressed”, a unique tracking number is assigned to the new message. Similarly, all messages coming into the network from an outside source that have not previously received a unique tracking identifier by the system receive a unique tracking identifier. These tracking identifiers are embedded in the emails as metadata or in some way linked to the corresponding email message.

Each network uses its own series of DSS Platform tracking identifiers, thus permitting the system to distinguish between emails originating from its network and emails from an outside network that also uses the DSS Platform.

When an email is determined to be the first email in a communication string, as determined by the lack of any pre-existing tracking identifier associated with the email, the email is designated as a root email and the DSS Platform assigns a unique tracking identifier to that email.

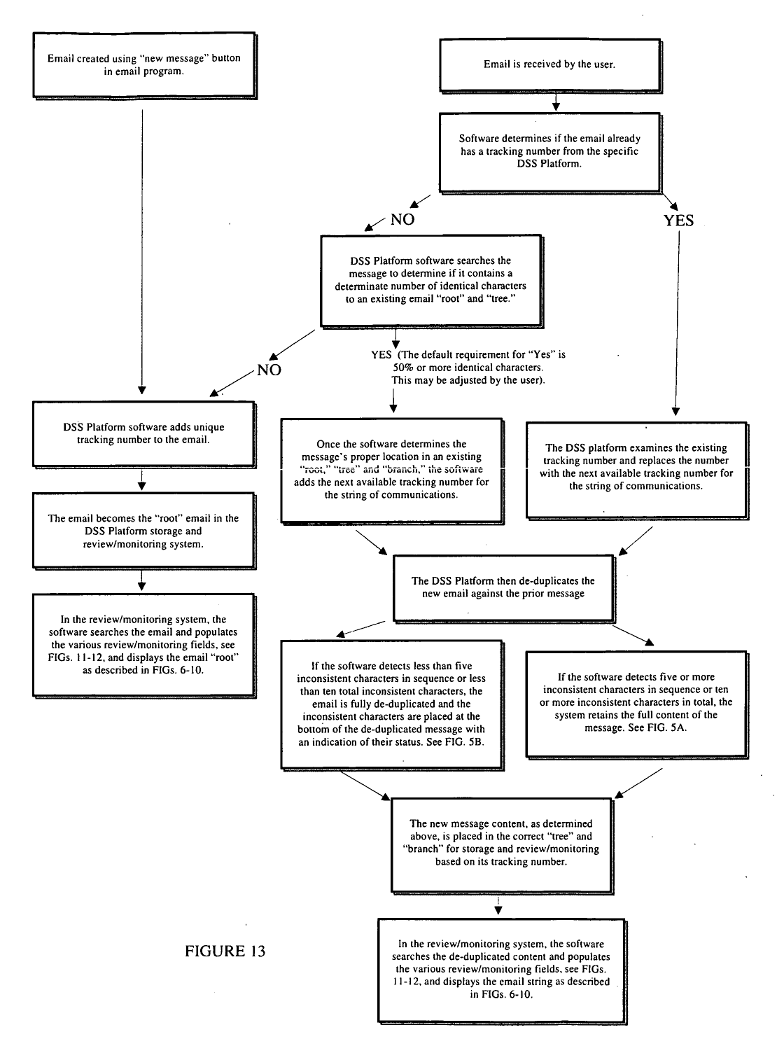

For monitoring/review purposes, the software analyzes the root email and populates various fields in the monitoring/review segment of the DSS Platform. See the exemplary partial views of FIGS. 11-12. The populated fields include the email participants, the sent time, the number of unique messages, the presence and identities of outside participants, key terms (e.g., words and phrases) contained in the email, and the email communication itself.

When a reply to or forwarding of the “root” email occurs, the tracking identifier allows the DSS Platform software to associate this subsequent reply or forwarded email with the original email, even if the “root” email traveled outside the network. Once identified as a related email, the DSS Platform assigns to the related message the next available tracking identifier for this chain of communications, beginning with the addition of a suffix, such as “a.1” after the original/root tracking identifier. The “.a” identifies this email as the first “branch” from the “root” email, meaning it is an email flowing directly from the original. The “0.1” identifies this as the first email of the particular “branch,” in this case the “a” branch.

When a related email is received, the software also compares the email to the “root” email and conducts a de-duplication process. The software compares the to/from/cc/bcc, subject, time, and message content, including signature lines. As an example, when only the reply to/from/cc/bcc, subject, time, and message is unique and the remainder of the email is a duplicate of the original email, the software removes the duplicate content for storing and monitoring/reviewing purposes. As such, only the unique to/from/cc/bcc, subject, time, and message content is added to the “tree.” This feature saves significant storage space and creates an easier and faster monitoring/reviewing platform. The DSS Platform software, however, retains a record of the de-duplication process, allowing the email thread to be restored to its original form at a later time. The storage space required to retain a record of the de-duplicated email information, however, is considerably smaller than required to retain numerous duplicate copies of identical email content.

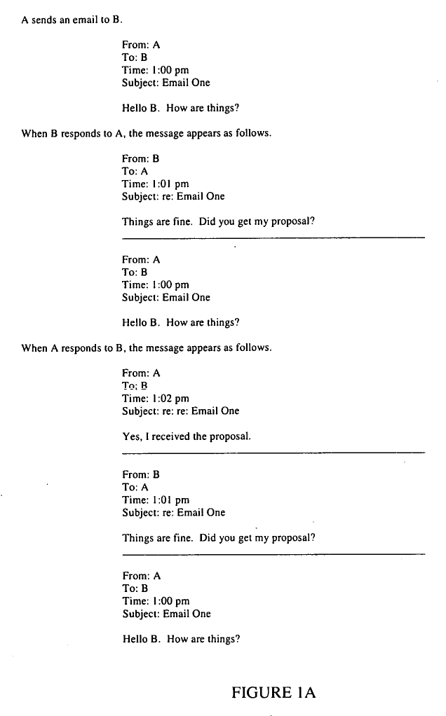

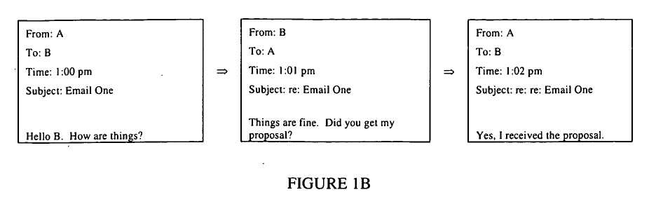

FIG. 1A illustrates a series of email messages or communications, including an initial email from A to B, a response from B to A and a further response from A to B. As illustrated, with each response the initial email and each subsequent email is displayed. This aggregation of the related emails is referred to as an email string. Display and storage of the initial email and the entire contents of the related emails requires substantial storage space.

FIG. 1B illustrates the same email content as stored (and displayed) according to the DSS platform of the present invention (but lacking the tracking identifiers taught by the present invention). The distinction between the conventional technique for storing, monitoring/reviewing emails of FIG. 1A and the DSS Platform technique for storing, monitoring/reviewing emails can be readily seen.

Of course, the email communication in FIGS. 1A and 1B is a simplistic version of the way emails flow back and forth in today's electronic environment. But the DSS Platform is designed to respond to such complexities in a way that simplifies the communications for storage and review.

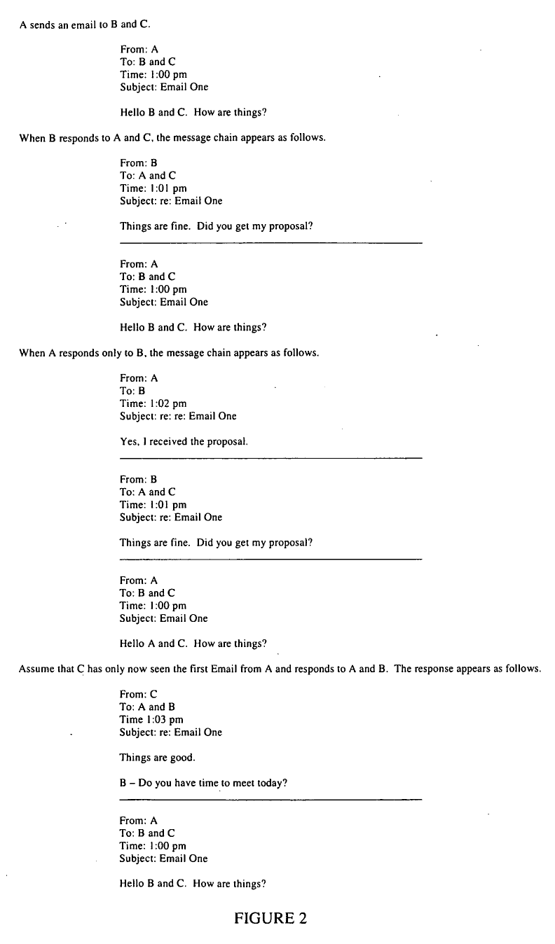

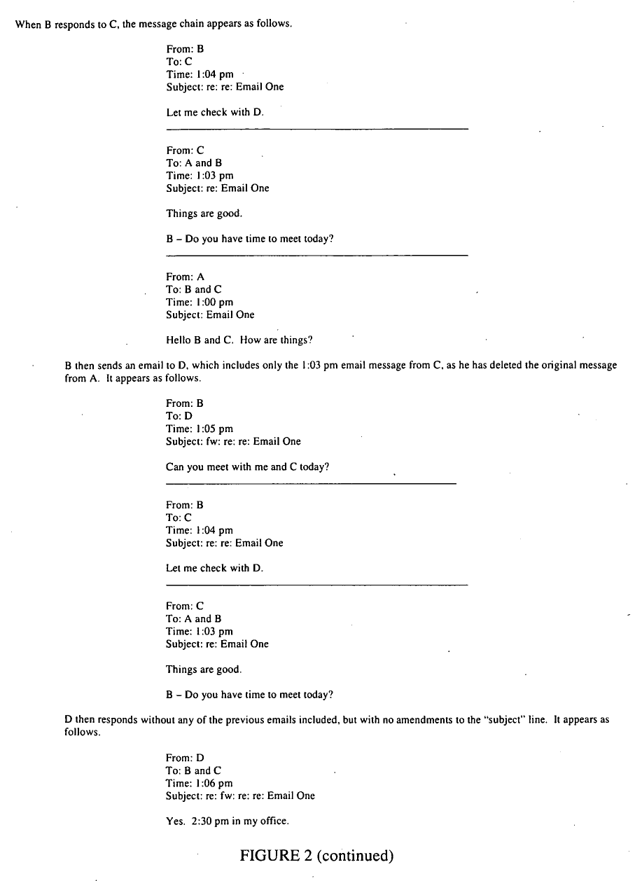

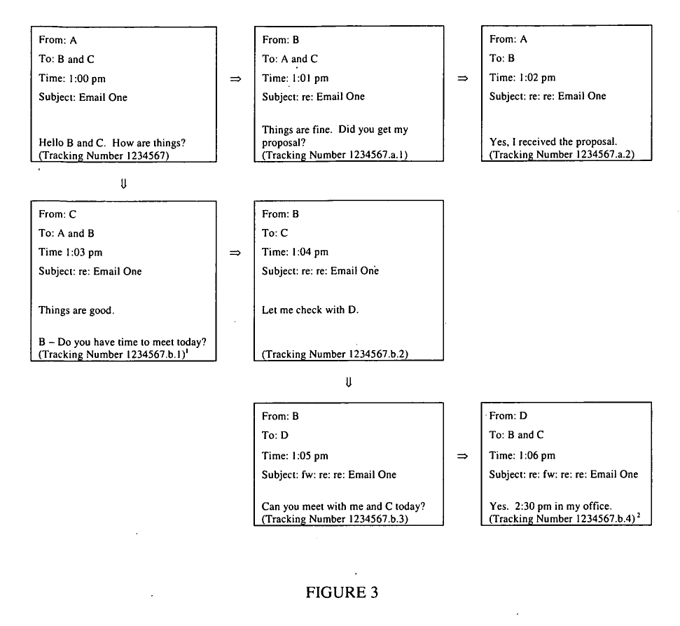

FIGS. 2 and 3 demonstrate how the DSS Platform operates in a more complex environment, which includes both a “root” email, a “tree,” and “branches.” As demonstrated in FIG. 2, a conventional email storage and review system retains the same text over and over again each time someone responds to the original message. As demonstrated in FIG. 3, however, the DSS Platform compresses the email chains and saves only the new text, thus requiring less storage space and making it easier and faster for a monitor/reviewer to analyze this email string. Whether for litigation, internal review, or government subpoena, the DSS Platform may save millions of dollars in storage and review fees, increase efficiency and response time, and place the corporation in a better position to understand the facts before anyone else.

For a monitor/reviewer, the series of emails in a conventional system, as illustrated in FIG. 2, presents several problems. First, because the conventional system saves each message separately, the reviewer must read the same earlier messages over and over again. Second, where earlier messages in a reply email or forwarded email have been deleted, the monitor/reviewer may not understand or comprehend the significance of the message when viewed in isolation. For instance, taken by itself, the final email from D in FIG. 2 is virtually meaningless. In reality, however, establishing the existence of this meeting may be vitally important. Third, understanding the way each of these messages relates to the others from a global perspective is all but impossible in a conventional system.

In the DSS Platform, however, the messages are compressed into an understandable and easily reviewed format, as illustrated in FIG. 3, for example. This format also saves significant storage space. If this much space and time can be saved with this relatively simple email communications string, the cost savings and advantages in the real world, where hundreds of millions of emails flow back and forth every day, is substantial.

FIG. 2 illustrates a more complex email string in which certain recipients respond to less than all of the other recipients and only certain messages are included in the various threads that emanate from the original email message.

FIG. 3 illustrates the tree structure created by the DSS platform for the emails of FIG. 2, each block in FIG. 3 depicting one email message and identifying the assigned tracking identifier for each email message.

In the example of FIGS. 2 and 3, the first message receives the tracking identifier 1234567 and becomes the “root” email message. The response from B is embedded with the base tracking identifier from the “root” message, 1234567, and is placed by the DSS platform in the “tree” as the second message with a tracking identifier of 1234567.a.1. The tracking system of the DSS platform has linked the first response to the first (root) message sent at 1:00 PM by annexing the “a.1” to the root email message 1234567.

The reply message from A to only B is once again placed in the correct “tree” identified by the base number 1234567 and has been assigned tracking identifier 1234567.a.2. This message is placed in the correct order because it contains a marker for the previous message's tracking identifier, 1234567.a.1. This message, therefore, is placed as the third message in the “tree” with the tracking identifier 1234567.a.2.

The DSS Platform restarts the tracking system at 1234567.b.1 for the message from C to A and B, rather than 1234567.a.3, because it is a new branch of the root email string.

Utilizing the DSS Platform, when an employee “pushes” the “reply” or “forward” button on the email application, the email system automatically links the new message to be sent with the original email. Therefore, even if D had removed the subject line from his response to B and C at 1:06 PM, the DSS Platform can determine from the unique tracking identifier assigned to the original email that D's response was generated in reply to the email message sent by B to D at 1:05 pm.

For monitoring/review purposes, once a related email has been identified and de-duplicated, it is analyzed by the software in the same manner as the “root” email and the various fields in the monitoring/review application are updated for the entire email chain. See FIGS. 11-12 as described below. The new message content, but not the duplicate content, is also added to the monitoring/reviewing screen as demonstrated in FIGS. 11-12.

Should a subsequent related message occur, such as the third email in FIG. 3, i.e., the email from A to B sent at 1:02 PM, the tracking identifier allows the software to distinguish whether the email is part of the existing branch, as indicated by the presence of the “.a.1” at the end of the tracking identifier, or whether the email is in response to the “root” email, as indicated by the lack of a suffix, such as “.a.1,” at the end of the tracking identifier.

Continuing with FIG. 3, the third email is in reply to the second email, it is not in reply to the “root” email. Therefore, the third email is assigned the original tracking identifier with the addition of a “.a.2” at the end. The “.a” indicates the email is part of the first “branch” from the “root” email. The “0.2” indicates this is the second email of the particular branch. As with the previous messages, the third message is de-duplicated for storage and monitoring/review purposes. The message is then analyzed by the monitoring/reviewing software and placed in the monitoring/reviewing format demonstrated in FIGS. 11-12.

An email that is a reply to the “root” email, as illustrated by the email sent at 1:03 PM in FIG. 3, the DSS Platform will be assign the original tracking identifier with a “.b.1” prefix to the reply email. The “b” indicates the email is part of a second “branch” from the “root” email. The “1” indicates this is the first email of the “b branch.” A “branch” can be formed from any email and multiple “branches” can form from the same email.

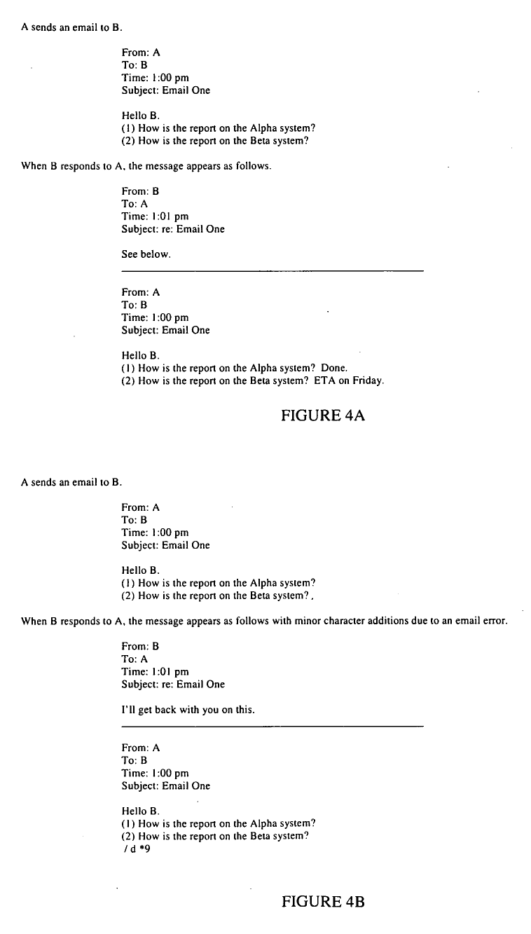

By applying the unique tracking identifier to emails, the DSS Platform ensures that even when someone changes the subject line or deletes most of the text from the original email message when replying or forwarding, the software can still track the communication and place it in the proper “tree” and “branch.” See FIGS. 3-4.

It is anticipated that actual tracking identifiers will include more characters than the example tracking identifiers shown here. Also, when there are more than 26 branches from an email, the tracking identifier continues with the prefix “aa.1” for the twenty-seventh branch followed by “ab.1” for the twenty-eighth branch, et seq.

It should also be noted that, when necessary, one may decompress the “tree” structure above and reconstruct the original emails in their conventional formats. This is accomplished by using the unique tracking identifiers to reconstruct the original email chains. While decompression is not necessary or desirable in most retrieval and review scenarios, it may be necessary to properly comply with litigation or subpoena document production requests.

Of course, the email communication in FIG. 1 is a simplistic version of the way emails flow back and forth in today's electronic environment. But the DSS Platform is designed to respond to such complexities in a way that simplifies the communications for storage and review.

FIGS. 2 and 3 demonstrate how the DSS Platform operates in a more complex environment, which includes both a “root” email, a “tree,” and “branches.” As demonstrated in FIG. 2, a conventional email storage and review system retains the same text over and over again each time someone responds to the original message. As demonstrated in FIG. 3, however, the DSS Platform compresses the email chains and saves only the new text, thus requiring less storage space and making it easier and faster for a monitor/reviewer to analyze this email string. Whether for litigation, internal review, or government subpoena, the DSS Platform may save millions of dollars in storage and review fees, increase efficiency and response time, and place the corporation in a better position to understand the facts before anyone else.

For a monitor/reviewer, the series of emails in a conventional system, as illustrated in FIG. 2, presents several problems. First, because the conventional system saves each message separately, the reviewer must read the same earlier messages over and over again. Second, where earlier messages in a reply email or forwarded email have been deleted, the monitor/reviewer may not understand or comprehend the significance of the message when viewed in isolation. For instance, taken by itself, the final email from D in FIG. 2 is virtually meaningless. In reality, however, establishing the existence of this meeting may be vitally important. Third, understanding the way each of these messages relates to the others from a global perspective is all but impossible in a conventional system.

In the DSS Platform, however, the messages are compressed into an understandable and easily reviewed format, as illustrated in FIG. 3, for example. This format also saves significant storage space. If this much space and time can be saved with this relatively simple email communications string, the cost savings and advantages in the real world, where hundreds of millions of emails flow back and forth every day, is substantial.

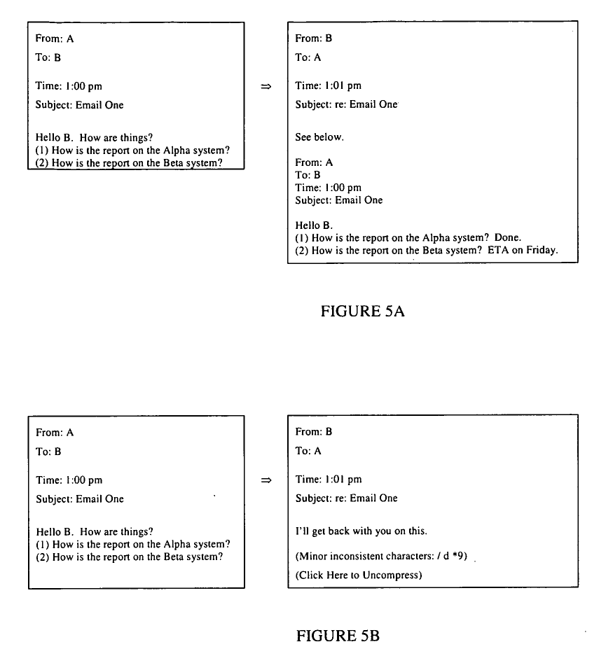

When text is added, either inadvertently or purposefully, to the original email message as part of the reply or forwarding process, this information is analyzed and retained for both storing and monitoring/reviewing purposes. See FIGS. 4A, 4B, 5A and 5B. This analysis and retention is accomplished during the de-duplication stage of the software's analysis. When an email being de-duplicated contains additional or inconsistent text or images from prior exchange(s), one of two outcomes will result.

First, if the software detects less than five inconsistent characters in sequence or less than ten total inconsistent characters, the emails are fully de-duplicated and the inconsistent characters are placed at the bottom of the de-duplicated message with an indication of their status. See for example FIG. 4B and its counterpart DSS display in FIG. 5B. The DSS platform also provides the user with an option to restore the full message should the monitor/reviewer determine that the characters may be significant. See the parenthetical entry in FIG. 5B “(Click Here to Uncompress).” This feature is available to prevent minor character inconsistencies that might result from, among other things, emails flowing into and out of the network interfering with the benefits of the DSS Platform.

Second, if the software detects five of more inconsistent characters in sequence or ten or more inconsistent characters in total, the system retains the full content of the relevant message. See FIG. 4A and its counterpart in FIG. 5A.

The number of inconsistent characters in sequence or the total number of inconsistent characters is user selectable. The parameters set forth above being merely exemplary.

### Forest View

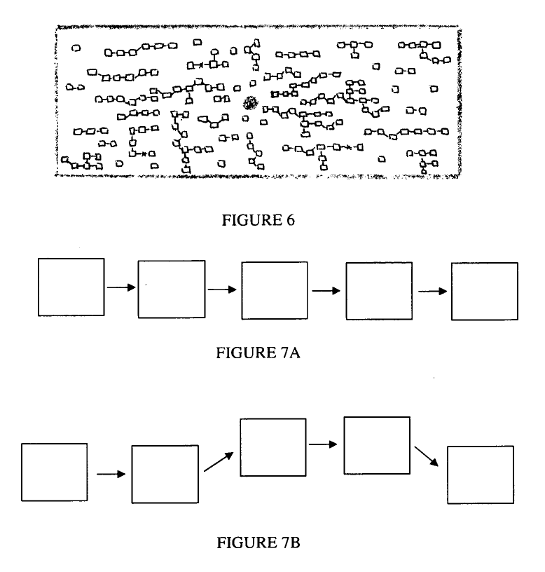

Another unique aspect of the DSS Platform is the “Forest View” for monitoring/reviewing emails either in real-time or during a later review of archived emails. With the “Forest View” displayed on a touch screen the user can navigate through the entire forest of emails being examined, zoom in on areas of interest, and focus the review from relevant “roots,” “trees,” and “branches.” From a global position, the “Forest View” is illustrated in FIG. 6. In another embodiment, the zoom process is initiated when a user mouse clicks on an area of interest.

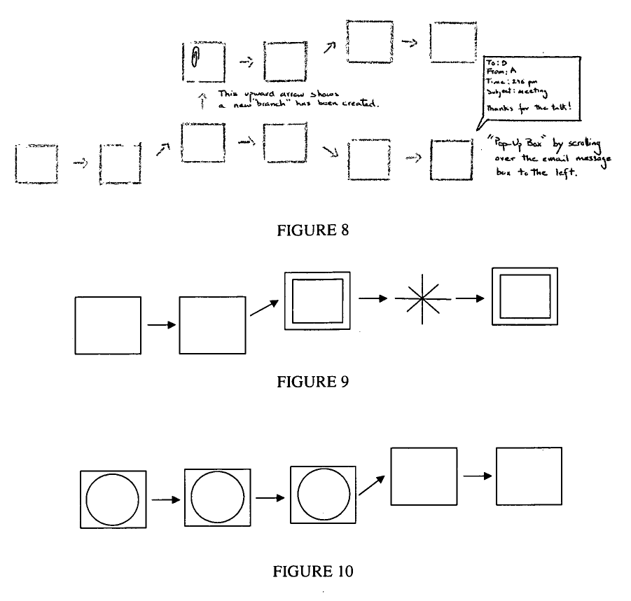

Emails within the entire corporate email forest appear in one of several ways:
(1) “Chain”—An email exchange that goes back and forth between two or more people. Each box represents an email message; the first box is the “root” email and the subsequent boxes contain the de-duplicated content from related emails. The vertical shift in the boxes indicates the addition of a new party to the email string. Such an email may remain between the original individuals the entire time (in which case the email chain is presented in a line) (see the FIG. 7A close up) or may, at some point, include new individuals (see the FIG. 7B close up). Each time a new party is added to the email exchange, the chain is off-set up or down from the line as shown in FIG. 7B, which serves as a visual cue to the monitor/reviewer.
(2) “Spoke and Wheel”—An email exchange that begins with one group and then splinters off to separate exchanges branching off from the original as illustrated in FIG. 8. A “branch” is created each time there is more than one email message resulting from the original message.
(3) “Offsite Exchange”—An email that goes outside the corporation. While the DSS system cannot track what happens to emails after they leave the network, such as where corporate emails are sent offsite, the system does track whether the email comes back inside the corporate network and links this email to the original interaction as demonstrated in FIG. 9.

The [symbol] symbol is used as a visual cue to show that someone outside the network is participating in the email.

The paper clip image in FIG. 8 indicates that the message contains an attachment. The attachment can be viewed by clicking on the symbol. When an attachment is opened, the DSS Platform offers the option of showing or hiding metadata contained within the electronic document.

A “pop-up” box containing the message can also be viewed by scrolling over any particular email message box in the global view of FIG. 8. Such a “pop-up” box is illustrated in FIG. 8.

The [symbol] symbol is used when an email is sent outside the network, travels in an outside network, and then returns to the corporation with new messages attached. See FIG. 9. As an example, A at Company X sends an email to B at Company Y. B then communicates with C, D, and E at Company Y, before sending a message back to A with the responses B received from C, D, and E. When the original tracking identifier from the prior email is still present and embedded in the message when it re-enters the Company X email system, the software recognizes the email and places it in the proper “tree” and “branch.” This feature is virtually impossible using existing programs. Where, however, for some reason, the tracking identifier is gone, the DSS Platform uses indicators such as to/from, time sent, subject line, and key words to determine if the communication from B back to A is properly placed in the “tree” created when A sent the original message to B.

The above described global picture view of the entire corporation's emails may be sorted any number of ways using the DSS Platform's search feature. As examples, a reviewer may choose to look at emails only from or to a particular individual or corporate unit, during a specific date or time frame, or containing particular terms in the subject line or body of the email.

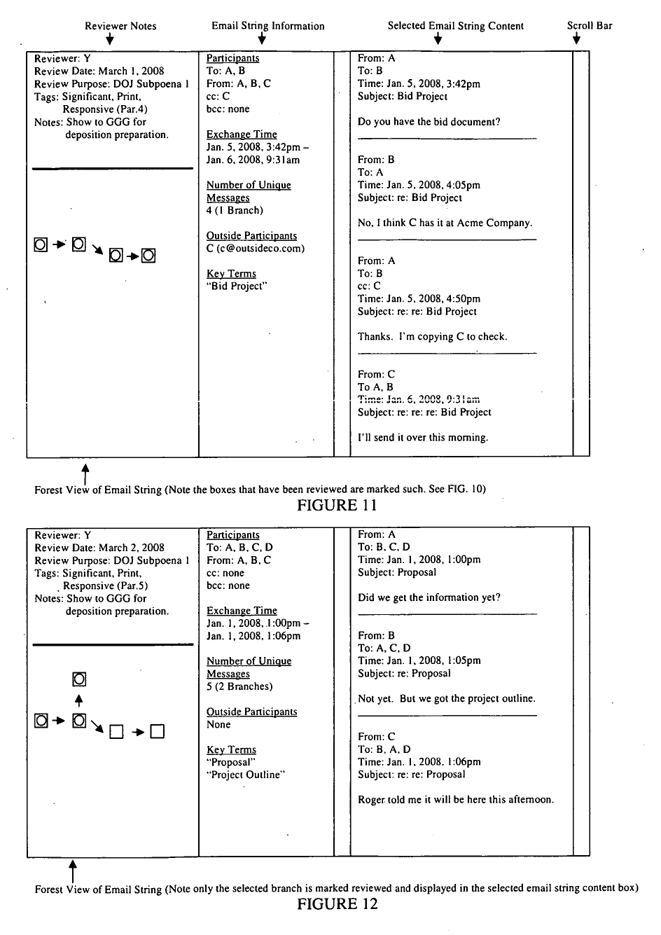

Once a smaller forest has been created using the selected parameters, the subset of emails may be saved so monitors/reviewers can return to it time and time again to continue their analysis. Further, monitors/reviewers can select to have email messages and email “trees” and “branches” that have been reviewed marked as such (“marked reviewed”). The marked review feature can, if desired, also include the name of the monitor/reviewer, the date/time of review, and the matter for which the review was conducted. The “marked reviewed” notation will be visible within the entire network of corporate emails so as to prevent others monitoring/reviewing utilizing different searches that have captured the same email message or email string from examining the marked email again. The marked reviewed messages in FIG. 10 are those with a circle.

Within a forest, the monitor/reviewer may also create a set of “tags” for tracking purposes. Such tags may include “Significant,” “For Printing,” “Deposition Binder,” “Hot Document,” “Privileged,” or other helpful terms. When such tags are being utilized, the tags appear in a box in the upper left corner and the responsive “roots” and “trees” are displayed in the forest view. By amending the search tags being utilized in the upper left corner, the responsive messages being displayed change accordingly.

At any point during a monitoring/reviewing process, the system allows a monitor/reviewer to search for, print, or download all email messages, “trees,” or “branches” containing one of the tags. The monitor/reviewer will also be presented with a notes field in which messages for reviewers may be added. As with the marked reviewed above, the tags will permanently attach to the email message or email chain in the entire network.

The marked reviewed indicator, tags and/or notes can be provided with the original emails for document production and printing purposes. Optionally, the user can hide any such indicators, tags and notes.

Obviously, viewing the entire forest of emails can be overwhelming when thousands of messages are captured. As such, once the forest is defined, the DSS Platform touch screen offers the ability to tap on an area of the forest and zoom in for a closer look. Before zooming in, the forest can be organized in a number of ways. For instance, the forest can be arranged clockwise in chronological order—thus, by tapping on the area surrounding “one o'clock,” the monitor/reviewer would zoom in on early exchanges. Alternatively, the system can sort for email chains containing similar terms and group them together in different areas of the forest.

Once the forest is organized in the manner best suited to the purpose of the particular monitoring/review and the monitor/reviewer zooms in sufficiently, the monitor/reviewer can select individual “roots” and “trees.” When a “root” and “tree” are selected, the monitor/reviewer leaves the total “forest view” as illustrated in FIG. 6, and enters a more specific view of this single “root” and “tree,” as illustrated in FIGS. 11 and 12. On the left will be the “root” and “tree” in the “Forest View,” and on the right will be the actual messages. When a particular “root” and “tree” is selected, the screen will also show the monitor/reviewer every individual who participated in the exchange, the beginning and ending dates of the exchanges, whether the email chain included participants from outside the corporation, how many email messages make up the “tree,” and any terms that are used several time. Further, the monitor/reviewer may conduct further search to see if a particular term appears in the message being read.

If the email chain comprises simple back and forth messages, the displayed image may appear as in FIG. 11. Note that if the forest of emails was generated using search terms, those terms in the email string will be highlighted.

If an exchange is complex, the reviewer may be prompted to select a branch to continue following. Only the reviewed branch will be marked reviewed, thus the reviewer can return to the other branch if relevant as demonstrated in FIG. 12.

Note that the reviewer can select to have the email messages on the left automatically marked reviewed as he or she scrolls down the column on the right to review each message. In the above example, the reviewer must click on the second “branch” for those messages to appear on the right. This prevents confusion regarding the progression of the messages.

### Working in a Live Network—Corporate Security

With millions of emails flowing back and forth within a company and then to unknown individuals on the outside before sometimes returning to the company, it is extremely difficult for corporate security teams to quickly and accurately examine ongoing email communications for security threats. Too often, corporate espionage or other inappropriate communications from employees are discovered only after the damage has been done and a follow-up review is being conducted.

The DSS Platform, however, provides for real-time monitoring of emails under an almost limitless number of criteria. The difference between using the DSS Platform to perform such monitoring and other “monitoring” systems is the ease with which security personnel can examine and understand the ongoing communications using the “root” and “tree” system of the “Forest View.” As such, rather than sifting through page after page of overlapping email chains, some of which are irrelevant, security personnel can examine the “Forest View,” isolate the relevant branch, and quickly examine the text straight through to determine if there is a real-time security breach occurring. Further, with the unique collection of information regarding participants, timing of the exchange, outside participants, and key terms constantly updating in real-time, security personnel can make real-time decisions more quickly about what is occurring at that very second.

### Remote Access

Whether using the system for document review after-the-fact or in a live network, the system offers the ability to grant selected users access over a secure and encrypted internet connection. This permits after-the-fact review or real-time review by personnel outside the corporation or corporate personnel operating from remote locations.

An overview flow chart of the software process according to one embodiment of the invention is illustrated in FIG. 13. A original email message is processed through the steps illustrated on the left side of FIG. 13, i.e., adding the unique tracking number (or identifier), identifying the email as the root email, and searching the email and populating the various fields associated with the DSS Platform.

A received email is processed through the steps illustrated on the right side of FIG. 13, i.e., determining if the email has a tracking number (or identifier), determining if the email contains a predetermined number of identical characters to an existing email root or tree branch, the appropriate tracking number is then assigned, the email is de-duplicated. The system then determines, based on the number of inconsistent characters, whether to retain the entire email or display the inconsistent characters with the de-duplicated email, the email is placed in the correct tree branch and the various fields associated with the DSS Platform are populated.

The present invention relates to a method of collecting, storing, monitoring, and reviewing electronic mail communications (“emails”) and attachments. The system comprises a /microprocessor/memory unit that intercepts email communications entering and exiting a computer network, e.g. a corporation's email servers. Each email is analyzed by the system and sorted to locate any related emails. Where the email is related to previous communications, it is de-duplicated and new content is placed with the existing email chain in a “root,” “tree,” and “branch” structure. All email communications are stored in this “compressed” manner, along with a supplemental record of each email in an original uncompressed format. Real time monitoring or after-the-fact review of the emails may be made utilizing the system's email review mechanism, which presents a visual overview of each email chain, including information regarding the time, participants (both from within and outside the existing network), and key terms. Furthermore, the system can be set to monitor or search for specific users, terms, or patterns and flag these emails for reviewers conducting real time monitoring or after-the-fact review.

The present invention can be embodied in the form of computer-implemented processes and apparatus for practicing those processes. The present invention can also be embodied in the form of computer program code containing computer-readable instructions embodied in tangible media, such as floppy diskettes, CD-ROMs, hard disks, or any other computer-readable storage medium, wherein when the computer program code is loaded into and executed by a computer or processor, the computer or processor becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer or processor, the computer or processor becomes an apparatus for practicing the invention. When implemented on a general-purpose computer, the computer program code segments configure the computer to create specific logic circuits or processing modules.

Any one or more of the above method steps may also be incorporated into a computer-based system including a processor and a memory comprising computer-readable instructions that, when executed by the processor, cause a computer to perform any one or more of the method steps above.

While the invention has been described with reference to various embodiments, it will be understood by those skilled in the art that various changes may be made and equivalent elements may be substituted for elements thereof without departing from the scope of the present invention. The scope of the present invention further includes any combination of the elements from the various embodiments set forth herein. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims.

What is claimed is:

1. A method for managing email messages, the method comprising:
(a) identifying a root email message sent by a first party to a second party;
(b) assigning a tracking identifier to the root email message;
(c) linking the tracking identifier and the root email message;
(d) identifying first branch email messages branching from the root email message, wherein each of the first branch email messages comprises an email message having one or more elements in common with the root email message;
(e) storing the root email message and elements of any first branch email message not previously stored;
(f) assigning to each first branch email message a same first branch identifier;
(g) assigning to each first branch email message a unique serial identifier identifying the location of each email message in the first branch;
(h) linking each first branch email message to the corresponding tracking identifier of the root email message, the first branch identifier and the unique serial identifier;
(i) repeating steps (d)-(h) for email messages branching from the root email message along branches other than the first branch; and
(j) displaying the root email message and elements of any branch email message that were not displayed as elements of a previously-displayed email message.

2. The method of claim 1 further comprising a step of decompressing and displaying the root email message and the first branch email messages to permit viewing all elements of the root email message and of the first branch email messages.

3. The method of clam 1 further comprising displaying in a tree form the items stored at the step (e).

4. The method of claim 3 further comprising a user selecting an area of the tree and in response thereto displaying additional details of the selected area.

5. The method of claim 3 wherein all first branch emails between the first party and the second party are displayed in a line within the tree and any related emails involving a third party are offset from the line.

6. The method of claim 1 wherein the step of linking the tracking identifier and the root email message comprises embedding the tracking identifier as metadata in the root email message.

7. The method of claim 1 wherein the elements of any first branch email message not previously stored comprise a first branch first email message having more than a first predetermined number of inconsistent characters in sequence when compared to a first branch second email message or having more than a second predetermined number of total inconsistent characters when compared to the first branch second email message.

8. The method of claim 7 wherein the first predetermined number is five and the second predetermined number is ten.

9. The method of claim 1 wherein the step (e) further comprises storing the root email message and for each first branch email message, recipient information, a time the first branch email message was sent, a subject of the first branch email message and new text present in the first branch email message.

10. The method of claim 1 wherein the elements relate to one or more of subject line contents, recipient and sender names, sent time, words, characters, or images appearing in a body of the email message, attachments to the email message and a signature line of the email message.

11. The method of claim 1 wherein the tracking identifier, the first branch identifier, and the serial identifier each comprise one or more numeric or alphanumeric characters.

12. The method of claim 1 wherein the tracking identifier, the first branch identifier and the serial identifier comprise metadata embedded into the corresponding email message.

13. The method of claim 1 wherein the steps (a) through (i) are executed in real time as email messages are created or executed after the email messages are created.

14. The method of claim 1 further comprising storing the first branch email messages in an original format.

15. The method of claim 1 wherein the method is executed in real time as the email messages are created or is executed after the email messages are created and stored.

16. The method of claim 1 wherein the step (e) further comprises storing the root email message and for each first branch email message, recipient information, a time the first branch email message was sent, a subject of the first branch email message and new text present in the first branch email message.

17. The method of claim 1 wherein the first party is a member of a first organization and the second party is a member of a second organization, and wherein when a first email message from the first party exits the first organization and later a second email branching from the first email message enters the first organization, the tracking identifier assigned to the first email message is linked to the second email message.

18. A computer-readable medium storing computer readable instructions that, when executed by a processor, cause a computer to manage email messages by performing the steps of:
(a) identifying a root email message sent by a first party to a second party;
(b) assigning a tracking identifier to the root email message;
(c) linking the tracking identifier and the root email message;
(d) identifying first branch email messages branching from the root email message, wherein each of the first branch email messages comprises an email message having one or more elements in common with the root email message;
(e) storing the root email message and elements of any first branch email message not previously stored;
(f) assigning to each first branch email message a same first branch identifier
(g) assigning to each first branch email message a unique serial identifier identifying the location of each email message in the first branch;
(h) linking each first branch email message to the corresponding tracking identifier of the root email message, the first branch identifier and the unique serial identifier; and
(i) repeating steps (d)-(h) for email messages branching from the root email message along branches other than the first branch.

19. The computer readable medium of claim 18 further comprising performing the step of (j) displaying the root email message and elements of any branch email message that were not displayed as elements of a previously-displayed email message.

20. A system for managing and displaying email messages, the system comprising;
a first element for identifying a root email message sent by a first party to a second party;
a second element for assigning a tracking identifier to the root email message;
a third element for linking the tracking identifier and the root email message;
a fourth element for identifying first branch email messages branching from the root email message, wherein each of the first branch email messages comprises an email message having one or more elements in common with the root email message;
storing the root email message and elements of any first branch email message not previously stored;
a fifth element for assigning to each first branch email message a same first branch identifier;
a sixth element for assigning to each first branch email message a unique serial identifier identifying the location of each email message in the first branch;
a seventh element for linking each first branch email message to the corresponding tracking identifier of the root email message, the first branch identifier and the unique serial identifier; and
an eighth element for displaying the root email message and elements of any branch email message that were not displayed as elements of a previously-displayed email message.
